(19) United States
(12) Patent Application Publication
(10) Pub. No.: US 2004/0148223 A1
(43) Pub. Date: Jul. 29, 2004

(54) Targeted direct marketing system and process for distributing coupons to information handling systems

(76) Inventors: Junaid Ghaffar, Austin, TX (US); Keith Hester, Austin, TX (US); Chandar Kamalanathan, Austin, TX (US)

Correspondence Address: HAMILTON & TERRILE, LLP, P.O. BOX 203518, AUSTIN, TX, 78720, US

(21) Appl. No.: 10/352,568

(22) Filed: Jan. 28, 2003

(51) Int. Cl. G06F 17/60

(52) U.S. Cl. 705/14

(57) ABSTRACT

Direct marketing subsystems associated with information handling systems download coupon lists from a direct marketing server, each coupon of a coupon list having one or more associated conditions and items offered for sale. A coupon relevance module analyzes the coupon list conditions to identify coupons that are relevant to the information handling system for display at the information handling system. Activation of a coupon initiates purchase of the item associated with the coupon by communication with the direct marketing server. A unique identifier of the information handling system associates selection of the coupon with an account for charging and delivery of the purchased item.

### BACKGROUND OF THE INVENTION

1. Field of the Invention

The present invention relates in general to the field of marketing information handling system components, and more particularly to a targeted direct marketing system and process for distributing coupons for display at information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling system performance capabilities are constantly being improved with hardware and software advances. Newly manufactured information handling systems typically include up-to-date components with the ability to incorporate future hardware and software improvements, such as by connecting improved peripheral devices with bus cards or external connectors. As improvements become available, manufacturers typically attempt to inform information handling system users of the improvements through advertising and marketing. Successful advertising of improvements results in both better informed consumers and improved revenue for manufacturers from sales related to the improvements. In some instances, manufacturers attempt to entice users into purchasing hardware and software improvements with coupon promotions that offer an item for sale at a special price made available if the user returns the coupon to the manufacturer. Coupons are often distributed by mail, in periodical advertisements and even by computer pop-up screens presented to a user when the user visits Web sites on the Internet.

One difficulty with coupon promotions is that information handling system users are often bombarded with irrelevant promotions not useful for their needs. Over saturated consumers tend to ignore all promotions, including those that offer information handling systems and components that are relevant to their needs, although information handling system users will respond to suggestive coupons that offer improvements or upgrades relevant to their systems. However, even where a coupon relates to a user's need for an information handling system improvement or upgrade, users are often hesitant to perform a purchase from coupons where the purchase involves returning the coupon with additional information or procedures of any complexity. Further, users are often hesitant to respond to coupons displayed on an information handling system unless the user understands and trusts the source of the coupon.

### SUMMARY OF THE INVENTION

Therefore a need has arisen for a method and system which targets coupons to information handling systems so that only relevant coupons are displayed at an information handling system.

In accordance with the present invention, a method and system are provided which substantially reduce the problems and difficulties associated with previous methods and systems for distributing coupons. Items promoted for sale through coupons displayed to an information handling system user are restricted based on an analysis of the configuration of the information handling system. Coupons are downloaded to the information handling system with associated coupon configuration parameters that define information handling system configurations relevant to the each coupon. Relevant coupons are displayed for the user to accept or decline and non-relevant coupons are discarded without display to the user.

More specifically, a direct marketing subsystem integrated with an information handling system periodically downloads coupons from a direct marketing server. The coupons are analyzed for relevance to the information handling system by comparing configuration parameters and conditions associated with each coupon to the information handling system configuration parameters. If the information handling system meets the conditions for display of a coupon, the coupon is displayed to the user with an activation button that allows the user to purchase the item associated with the coupon. Activation for a purchase sends a promotion code that identifies the coupon and the information handling system to the direct marketing server. Account information associated with the information handling system is gathered by the marketing server from an account database and confirmed with the user of the information handling system, such as the payment and delivery account information used to originally ship the information handling system. Once the account information and purchase of the coupon item are confirmed by the user, the direct marketing server coordinates delivery of purchased coupon item to the user.

The present invention provides a number of important technical advantages. One example of an important technical advantage is that coupons for information handling systems are targeted for distribution based on the needs of the information handling system that displays the coupon. Coupons are displayed at the information handling system to promote offers for relevant items, such as upgrades or attractive deals for hardware, software and supplies, based on analysis of configuration of the information handling system. Analysis of information handling system configuration parameters reduces the display of non-relevant coupons by comparing the configuration parameters with coupon configuration parameters that define information handling systems having a relationship to the offered item. For instance, an offer for a DSL modem need not be displayed at an information handling system that already is configured with a DSL modem.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for targeting coupons to information handling systems; and

FIG. 2 depicts a process for targeting coupons to information handling systems.

### DETAILED DESCRIPTION

Targeting of coupons to information handling systems based on the configuration parameters of each information handling system limits the display of coupons at an information handling system to those coupons relevant to that information handling system and provides simplified purchase of items associated with coupons. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (1/O) devices, such as a keyboard, a mouse, and a video display. The information handling system may also include one or more buses operable to transmit communications between the various hardware components.

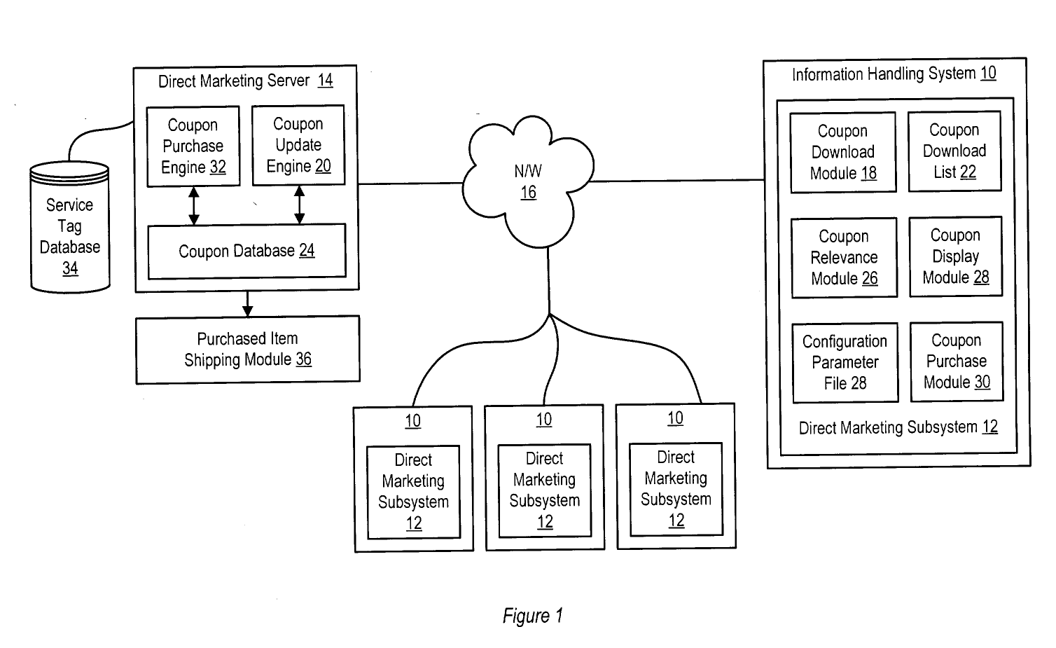

Referring now to FIG. 1, a block diagram depicts a system for targeting coupons to information handling systems 10. Each information handling system 10 includes an integrated direct marketing subsystem 12 that downloads coupons from a direct marketing server 14 through a network 16, compares the downloaded coupons with the information handling system configuration parameters to determine relevant and non-relevant coupons, displays relevant coupons at the information handling system and disregards non-relevant coupons. If a user of an information handling system 10 elects to purchase an item associated with a coupon, activation of the coupon communicates the purchase to direct marketing server 14 which coordinates payment and shipping of the item.

Direct marketing subsystem 12 downloads a coupon list with a coupon download module 18 that communicates through network 16 with a coupon update engine 20 of direct marketing server 14. Coupon download module 18 periodically queries coupon update engine 20 to download current coupons to a coupon download list 22. For instance, coupon download module 18 obtains a time for the most recent previous download from coupon download list 22 and provides the time to coupon update engine 20. Coupon update engine 20 accesses a coupon database 24 to prepare a list of coupons added since the last download time and formulates the coupons of the list as an Extensible Mark-up Language (XML) file for transfer through network 16 to coupon download module 18. Coupon download module 18 saves the XML coupons to coupon download list 22.

A coupon relevance module 26 analyzes the coupons of coupon download list 22 to identify coupons as relevant or non-relevant to the information handling system 10. Coupons identified as relevant are prepared for display to the user of the information handling system while coupons identified as non-relevant are discarded without display to the user. Coupon relevance module 26 determines the relevance of a coupon by comparing configuration parameters of the information handling system with configuration parameters associated with the coupon. For instance, a configuration parameter file 28, such as the Windows Management Instrumentation (WMI) table, lists hardware and software configuration parameters, such as component and software names and versions. Each coupon is associated with a list of one or more configuration parameters and, in some instances, a logical relationship for application to the configuration parameters listed in information handling system configuration parameter file 28. For instance, a coupon's configuration parameters may include a predetermined version of a hardware or software component and a “present” logical relationship so that the coupon is identified as relevant if the predetermined version is present and non-relevant if the predetermined version is not present. In such an example, the coupon may offer an updated version for sale. Alternatively, a coupon's configuration parameters may include a predetermined hardware or software component and an “absent” logical relationship so that the coupon is identified as relevant if the predetermined item is present and non-relevant if the item is absent. In such an example, the coupon may offer an item for sale that is incompatible with the predetermined component. Complex logical relationships for determining the relevance or non-relevance of a coupon may be states as Boolean logical expressions and associated with one or more coupons of coupon download list 22.

A coupon display module 28 obtains coupons identified as relevant and displays the relevant coupons at the information handling system in a desired manner and at a desired time. For instance, a coupon that offers a DSL modem and DSL service from a predetermined provider for sale may include as configuration parameters the absence of a DSL modem and the presence of dial-up service with the predetermined provider. The coupon is identified as relevant by coupon relevance module 26 if information handling system 10 has configuration parameters consistent with the absence of a DSL modem and the presence of dial-up service with the provider. Coupon display module 28 displays the DSL coupon at a selected time and in a selected manner, such as a pop-up window displayed at start-up of information handling system 10. Alternatively, the DSL coupon may include instructions to display during a targeted activity, such as in a browser window when the user is using the dial-up service to inform the user about the availability of improved speed with the DSL modem and service offered for sale by the coupon.

A user of information handling system 10 initiates purchase of an item associated with a coupon by activation of the coupon, such as by clicking on the coupon with a mouse pointer. A coupon purchase module 30 accepts activation of the coupon and communicates a purchase request through network 16 to direct marketing server 14 with information, such as a coupon identifier and an information handling system unique service tag, that identifies the information handling system from which the purchase request for the coupon item was made. A coupon purchase engine 32 receives a code with the information from coupon purchase module 30 and parses the code to obtain the unique service tag and coupon identification. Account information, such as payment and delivery address information, associated with the service tag is obtained from a service tag database 34 and confirmed by communication between coupon purchase module 30 and coupon purchase engine 32. The validity of the coupon is confirmed with coupon database 24, for instance by looking up the coupon identification and confirming that the promotion associated with the coupon has not terminated. Coupon purchase engine 32 forwards confirmed purchases to a purchased item shipping module 36 that coordinates payment and shipping for items associated with the coupon.

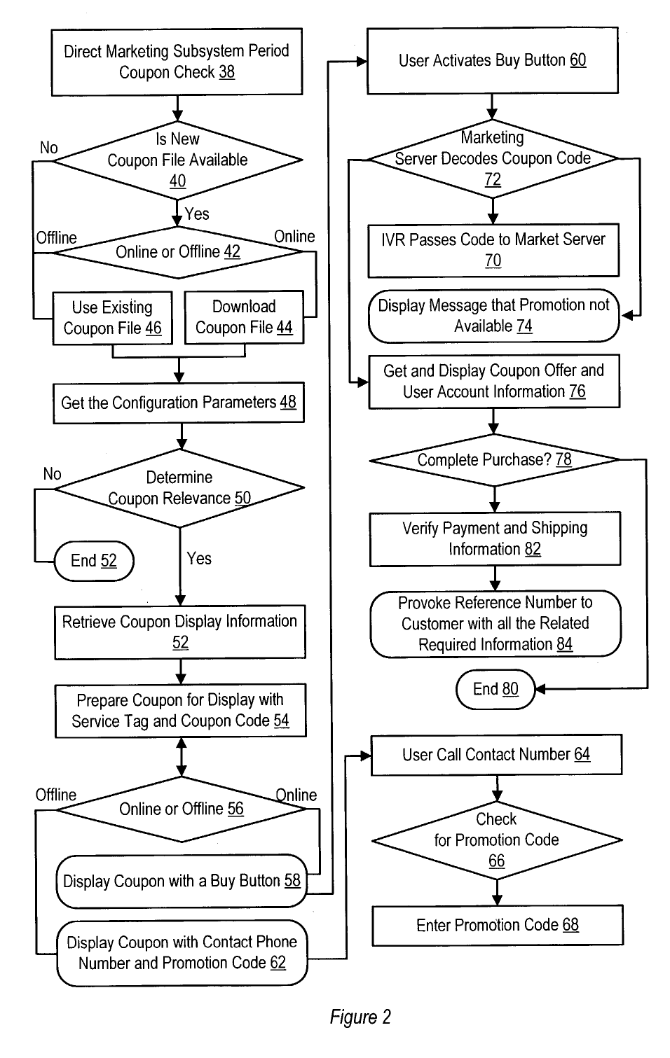

Referring now to FIG. 2, a flow diagram depicts a process for targeting coupons to information handling systems based on system configuration parameters. The process begins at step 38 with initiation of a periodic coupon check by direct marketing subsystem 12. At step 40 a determination is made of whether a new coupon file is available. If a new coupon file is available, the process continues to step 42 for a determination of whether the information handling system is on-line and interfaced with the network or off-line. If the information handling system is on-line, the process continues to step 44 for a download of the coupon file. If at step 42 the information handling system is off-line or, at step 40 a determination is made that no new coupons are available, the process continues to step 46 to use the existing coupon file.

At step 48, the configuration parameters of the information handling system are retrieved for comparison with the coupon configuration parameters. At step 50, a determination is made of the relevance of each coupon in the coupon list by comparing the information handling system configuration parameters with each coupon's configuration parameters and conditions. If the configuration parameters of the information handling system do not match the coupon configuration parameters and conditions, the coupon is identified as non-relevant and the process ends at step 52. If the configuration parameters of the information handling system do match the coupon configuration parameters and conditions, the process continues to step 52 at which the coupon display information is retrieved. For instance, graphical display information is retrieved from downloaded coupon files or from a network site. At step 54, the coupon is prepared for display by associating the information handling system service tag unique identifier and the coupon identification with the graphical display.

At 56 a determination is made of whether the information handling system is on-line or off-line. If on-line, the process continues to step 58 at which the coupon is displayed with a buy button available for activation at step 60 by the user of the information handling system, which results in the sending of the coupon code and service tag to the marketing server. If off-line, the process continues to step 62 for display of the coupon with a telephone contact number and promotion code that identifies the information handling system and the item associated with the coupon. At step 64, the user dials the contact phone number and, at step 66 is queried for the promotion code. At step 68, the user inputs the promotion code, such as a numeric code input into an interactive voice response unit (IVRU), and at step 70 the IVRU provides the promotion code to the marketing server.

At step 72, the marketing server decodes the code received through the coupon activation or user telephone input to identify the coupon and information handling system. If the promotion associated with the coupon is no longer available, such as due to termination of the offer or selling out of the item, the process continues to step 74 for display of a message that the coupon is no longer valid. If the promotion remains available, the process continues to step 76 at which the coupon offer and user account information are retrieved and displayed. At step 78, the user is requested to confirm the purchase. If the purchase is not confirmed, the process ends at step 80 without completion of the purchase. If the purchase is confirmed, at step 82 the user is requested to confirm the account and shipping information and, at step 84 is provided with a reference number and invoice reflecting completion of the sale of the coupon item.

Although the present invention has been described in detail, it should be understood that various changes, substitutions and alterations can be made hereto without departing from the spirit and scope of the invention as defined by the appended claims.

What is claimed is:

1. A system for direct marketing coupons to information handling systems, the system comprising:
a direct marketing server having plural coupons, each coupon associated with one or more information handling system configuration parameters and an offer to sell an item;
plural information handling systems interfaced with the direct marketing server, each information handling system having configuration parameters; and
a direct marketing subsystem integrated with each information handling system and operable to download coupons from the direct marketing server, compare the downloaded coupons with the information handling system configuration parameters to determine relevant and non-relevant coupons, display relevant coupons at the information handling system and disregard non-relevant coupons.

2. The system of claim 1 wherein the direct marketing subsystem determines non-relevant the coupons having one or more configuration parameters that match an information handling system configuration parameter.

3. The system of claim 1 wherein the direct marketing subsystem determines relevant the coupons having one or more configuration parameters that match an information handling system configuration parameter.

4. The system of claim 1 wherein the direct marketing subsystem is further operable to purchase the offered item associated with the coupon by activation of the coupon at the information handling system and communicating the purchase to the direct marketing server.

5. The system of claim 4 wherein the direct marketing server is operable to validate the coupon and initiate shipment of the purchased item to the information handling system.

6. The system of claim 5 wherein the direct marketing server initiates shipment by associating account information with the information handling system and confirming the account information with a user of the information handling system.

7. The system of claim 1 wherein the direct marketing subsystems interface with the direct marketing server at predetermined times to download coupons and wherein the direct marketing server time stamps coupons so that the direct marketing subsystem downloads only coupons posted after the most recent interface time.

8. A method for distributing coupons to information handling systems, the method comprising:
posting coupons at a direct marketing server, each coupon associated with one or more information handling system configuration parameters and an offer to sell an item;
downloading the coupons at an information handling system;
comparing the information handling system configuration parameters with each of the coupon configuration parameters to identify coupons relevant to the information handling system; and
displaying relevant coupons at the information handling system.

9. The method of claim 8 further comprising:
discarding non-relevant coupons without display at the information handling system.

10. The method of claim 9 further comprising:
activating a displayed coupon to initiated purchase of the item associated with the activated coupon; and
communicating activation of the coupon to the direct marketing server to complete purchase of the item.

11. The method of claim 10 further comprising:
associating a coupon activation with account information at the direct marketing server;
communicating from the direct marketing server to the information handling system to confirm the account information; and
coordinating at the direct marketing server the delivery of the item to the information handling system.

12. The method of claim 8 wherein comparing the information handling system configuration parameters further comprises identifying a coupon as relevant that has configuration parameters that match one or more of the information handling system configuration parameters.

13. The method of claim 8 wherein comparing the information handling system configuration parameters further comprises identifying a coupon as relevant that has configuration parameters that fail to match one or more of the information handling system configuration parameters.

14. The method of claim 8 further comprising expressing the information handling system configuration parameters associated with a coupon as a logical expression.

15. The method of claim 8 wherein downloading the coupons further comprises formulating the coupons as an Extensible Mark-up Language file transferred to the information handling system.

16. An information handling system comprising:
a configuration of hardware and software components operable to process information;
a coupon download module operable to download a coupon list to the information handling system, the coupon list having one or more coupons, each coupon associated with conditions and an offer to sell an item;
a coupon relevance module operable to apply the conditions of each coupon to the configuration of hardware and software components to identify relevant coupons; and
a display module operable to display relevant components at the information handling system.

17. The information handling system of claim 16 further comprising a coupon purchase module operable to select a coupon displayed at the information handling system to purchase the item associated with the coupon.

18. The information handling system of claim 16 wherein the coupon list conditions comprise one or more configuration parameters that are present or absent from the information handling system to make an associated coupon relevant.

19. The information handling system of claim 16 wherein the coupon relevance module is further operable to discard non-relevant coupons.

20. The information handling system of claim 16 wherein a coupon comprises an offer to sell an upgrade item for upgrading a hardware or software component of the information handling system configuration.
